(19) United States
(12) Patent Application Publication
(10) Pub. No.: US 2026/0037799 A1
(43) Pub. Date: Feb. 5, 2026

(54) DEEP LEARNING-BASED APPARATUS AND METHOD FOR DETECTING PROFANITY

(71) Applicant: CHUNG ANG UNIVERSITY INDUSTRY ACADEMIC COOPERATION FOUNDATION, Seoul (KR)

(72) Inventors: YOUNG BIN KIM, Seoul (KR); SEUNG UK YU, Chungcheongbuk-do (KR)

(21) Appl. No.: 19/284,918

(22) Filed: Jul. 30, 2025

(30) Foreign Application Priority Data
Jul. 30, 2024 (KR) 10-2024-0101250

(51) Int. Cl. G06N 3/08; G06F 40/284

(52) U.S. Cl. CPC G06N 3/08; G06F 40/284

(57) ABSTRACT

A method for detecting profanity according to an embodiment is performed in a computing device that includes one or more processors and a memory storing one or more programs executed by the one or more processors includes acquiring sequence data converted from a sentence input by a user, and generating embedded data containing one or more tokens by embedding the acquired sequence data, and training a neural network model to output information on whether the sentence contains profanity by inputting the generated embedded data into the neural network model.

### CROSS-REFERENCE TO RELATED APPLICATION AND CLAIM OF PRIORITY

This application claims the benefit under 35 USC § 119 of Korean Patent Application No. 10-2024-0101250, filed on Jul. 30, 2024, in the Korean Intellectual Property Office, the entire disclosure of which is incorporated herein by reference for all purposes.

### BACKGROUND

### 1. Technical Field

Embodiments of the present disclosure relate to the technology of a deep learning-based apparatus and method for detecting profanity.

### 2. Description of Related Art

As information and communication technology becomes more common, communication in virtual spaces such as SNS or/and Internet communities is becoming a daily occurrence.

Communication in virtual spaces is done anonymously or without directly meeting the other person's face and voice, and thus the use of profanity is more frequent than communication in real life, which adversely affects proper language usage and offends many people.

To prevent this, technologies related to profanity filtering have been continuously developed and utilized. However, in the case of the conventional technology, after performing a plurality of attentions, only the result of the last attention is used to determine the presence of profanity, and thus there is a limitation that although it is excellent for detecting general profanity, the detection sensitivity for deformed profanity is low. Accordingly, a profanity detection technology with high detection sensitivity even for deformed profanity is required as well.

Examples of related art include Korean Registered Patent Publication No. 10-2618060 (2023.12.27)

### SUMMARY

Embodiments of the present disclosure are directed to providing a profanity detection technology with high detection sensitivity even for deformed profanity is required as well.

A method for detecting profanity according to an embodiment of the present disclosure is performed in a computing device that includes one or more processors and a memory storing one or more programs executed by the one or more processors, the method including acquiring sequence data converted from a sentence input by a user, and generating embedded data containing one or more tokens by embedding the acquired sequence data, and training a neural network model to output information on whether the sentence contains profanity by inputting the generated embedded data into the neural network model.

The neural network model may include a neural network configured to derive information on whether the sentence contains profanity by analyzing the acquired embedded data, and the training of the neural network model may include adjusting weights of the parameters constituting the neural network of the neural network model so that a difference between the information derived on whether the sentence contains profanity and information labeled on whether the sentence contains profanity is minimized.

The training of the neural network model may include deriving a plurality of sequential CLS tokens each corresponding to each of the attention layers by sequentially passing the embedded data through a plurality of attention layers that perform attention, deriving a final token from two or more CLS tokens among the plurality of CLS tokens according to a preset criterion, and classifying whether the sentence contains profanity based on the final token.

The final token may be derived by averaging of the plurality of CLS tokens.

The final token may be derived from the largest CLS token among the plurality of CLS tokens.

The final token may be derived by combining a first CLS token and a last CLS token among the plurality of sequential CLS tokens.

The final token may be derived by combining the plurality of CLS tokens after applying a weight to each of the plurality of CLS tokens.

A first CLS token and a last CLS token among the plurality of sequential CLS tokens may have a greater weight than that of the remaining CLS tokens.

The weights of the plurality of sequential CLS tokens may gradually decrease and then increase from the first CLS token to the last CLS token among the plurality of sequential CLS tokens.

An apparatus for detecting profanity according to an embodiment of the present disclosure includes one or more processors and a memory storing one or more programs executed by the one or more processors, the apparatus including an embedding module configured to acquire sequence data converted from a sentence input by a user, and to generate embedded data containing one or more tokens by embedding the acquired sequence data, and a determination module configured to train a neural network model to output information on whether the sentence contains profanity by inputting the generated embedded data into the neural network model.

A computer program according to an embodiment of the present disclosure is stored in a non-transitory computer readable storage medium, in which the computer program includes one or more instructions, and the instructions, when executed by a computing device including one or more processors, cause the computing device to perform: acquiring sequence data converted from a sentence input by a user, and generating embedded data containing one or more tokens by embedding the acquired sequence data; and training a neural network model to output information on whether the sentence contains profanity by inputting the generated embedded data into the neural network model.

### BRIEF DESCRIPTION OF THE DRAWINGS

The present disclosure may be easily understood by combining the following detailed description and the accompanying drawings, in which reference numerals represent structural elements.

FIG. 1 is a flowchart illustrating a method for detecting profanity according to an embodiment of the present disclosure.

FIG. 2 is a block diagram schematically illustrating a configuration of an apparatus for detecting profanity according to an embodiment of the present disclosure.

FIG. 3 is a flowchart illustrating a method for generating, by a determination module, information on whether a sentence contains profanity through a neural network that derives information on whether a sentence contains profanity, according to an embodiment of the present disclosure.

FIGS. 4 to 7 are diagrams illustrating a method for generating, by a determination module, information on whether a sentence contains profanity through one or more attention layers from embedded data, in an apparatus for detecting profanity according to an embodiment of the present disclosure.

FIG. 8 is a diagram illustrating a method for assigning, by a determination module, weights to a plurality of CLS tokens through a plurality of attention layers, in an apparatus for detecting profanity according to an embodiment of the present disclosure.

FIG. 9 is a block diagram for illustratively describing a computing environment including a computing device suitable for use in exemplary embodiments.

### DETAILED DESCRIPTION

Hereinafter, specific embodiments of the present invention will be described with reference to the drawings. The following detailed description is provided to facilitate a comprehensive understanding of the methods, apparatuses, and/or systems described herein. However, this is only an example and the present invention is not limited thereto.

In describing embodiments of the present invention, if it is determined that a specific description of a related known function of the preset invention may unnecessarily obscure the gist of the present invention, the detailed description thereof will be omitted. The terms described below are terms defined in consideration of the functions in the present invention, and vary depending on the intention or custom of the user or operator. Therefore, the definition should be made based on the contents throughout this specification. The terminology used in the detailed description is for the purpose of describing embodiments of the present invention only and should not be construed as limiting. Unless expressly used otherwise, singular forms include plural forms. In this description, the terms “including” or “comprising” are intended to refer to certain features, numbers, steps, operations, elements, portions or combinations thereof, and should not be construed to exclude the presence or possibility of one or more other features, numbers, steps, operations, elements, portions or combinations thereof other than those described.

In addition, the terms first, second, etc. may be used to describe various components, but the components should not be limited by the terms. The terms may be used for the purpose of distinguishing one component from another component. For example, without departing from the scope of the present invention, a first component may be referred to as a second component, and similarly, a second component may also be referred to as a first component.

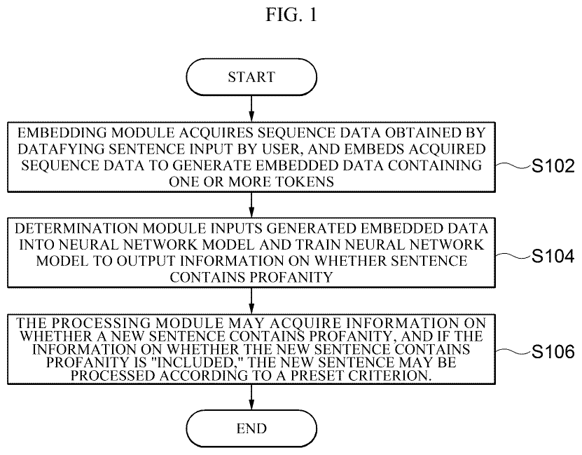

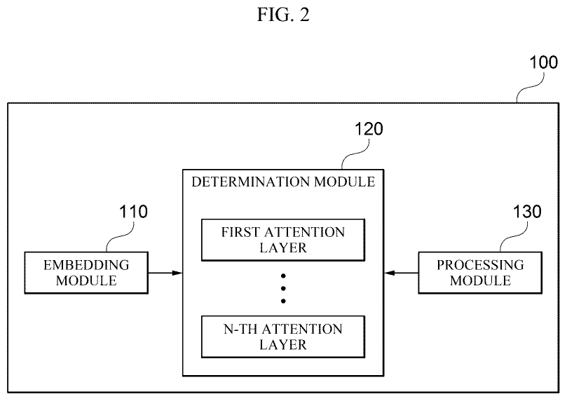

FIG. 1 is a flowchart illustrating a method for detecting profanity according to an embodiment of the present disclosure. Although the method is described as being divided into a plurality of steps in the illustrated flowchart, at least some of the steps may be performed in a different order, performed together by being combined with other steps, omitted, performed by being divided into sub-steps and, or performed by adding one or more steps (not shown). FIG. 2 is a block diagram schematically illustrating a configuration of an apparatus for detecting profanity according to an embodiment of the present disclosure.

Referring to FIGS. 1 and 2, in step S102, an embedding module 110 may acquire sequence data converted from a sentence input by a user, and generating embedded data containing one or more tokens by embedding the acquired sequence data.

Specifically, a sentence may be a set of a plurality of phrases, and a set of the plurality of phrases may be datafied to become sequence data. The embedding module 110 may generate embedded data by passing the sequence data through an embedding neural network (embedding layer) as a set of tokens, which are vectors in a computing space. The embedded data may be an input value of a determination module 120. In addition, the embedded data may contain information on whether the sentence contains profanity. The information on whether the sentence contains information may be information labeled as either “included” or “not included.” The embedding module 110 may transmit the embedded data to the determination module 120.

In step S104, the determination module 120 may input the generated embedded data into a neural network model and train the neural network model to output information on whether the sentence contains profanity.

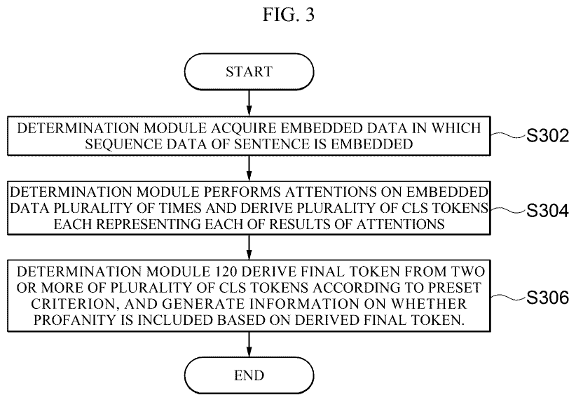

Specifically, the determination module 120 may generate a neural network model including a neural network that analyzes the acquired embedded data to derive information on whether the sentence contains profanity. The determination module may train a learning model by adjusting weights of parameters constituting the neural network of the neural network model so that a difference between the information derived on whether the sentence contains profanity and information labeled on whether the sentence contains profanity is minimized. In this case, the neural network included in the neural network model may include one or more attention layers. In an exemplary embodiment, the attention layer may be a self-attention layer that performs self-attention. Specific details of the determination module 120 generating the information on whether the sentence contains profanity through the neural network that derives the information on whether the sentence contains profanity will be described below with reference to FIGS. 3 to 7.

The determination module 120 may transmit the information on whether the sentence contains profanity to a processing module 130.

In step S106, the processing module 130 may acquire information on whether a new sentence contains profanity, and if the information on whether the new sentence contains profanity is “included,” the new sentence may be processed according to a preset criterion.

Specifically, the processing module 130 may acquire information from the determination module on whether the new sentence input by the user contains profanity. In an exemplary embodiment, if the information on whether the new sentence contains profanity is “included,” the processing module 130 may block the new sentence from being output to a screen of another user. In addition, the processing module 130 may block the new sentence from being stored in a database that may be output to the screen of another user. In addition, the processing module 130 may output warning characters, etc. to a screen of a person who input the new sentence.

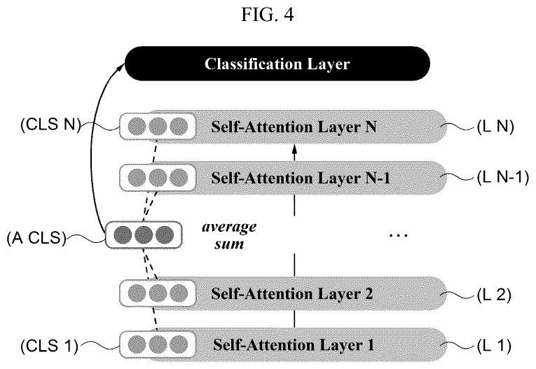

FIG. 3 is a flowchart illustrating a method for generating, by a determination module, information on whether a sentence contains profanity through a neural network that derives information on whether a sentence contains profanity, according to an embodiment of the present disclosure. Although the method is described as being divided into a plurality of steps in the illustrated flowchart, at least some of the steps may be performed in a different order, performed together by being combined with other steps, omitted, performed by being divided into sub-steps and, or performed by adding one or more steps (not shown). In addition, FIGS. 4 to 7 are diagrams illustrating a method for generating, by a determination module, information on whether a sentence contains profanity through one or more attention layers from embedded data, in an apparatus for detecting profanity according to an embodiment of the present disclosure.

Referring to FIGS. 3 to 7, in step S302, the determination module 120 may acquire embedded data in which sequence data of a sentence is embedded.

Specifically, the determination module 120 may acquire embedded data in which the sentence input by the user is datafied and embedded from the embedding module 110. In addition, the determination module 120 may acquire embedded data from a database previously stored as a training data set.

In step S304, the determination module 120 may perform attentions on the embedded data a plurality of times and derive a plurality of CLS tokens each representing each of the results of attentions.

Specifically, as shown in FIGS. 4 to 7, the neural network that derives information on whether the sentence contains profanity may include N attention layers. In an exemplary embodiment, the attention layer may be a self-attention layer that performs self-attention. Meanwhile, the classification token (CLS token) may be a vector representing the result of passing the embedded data through the attention layer. The CLS token may have as many dimensions as the number of tokens included in the embedded data. The CLS token may specify a specific value for each dimension.

The determination module 120 may derive a first CLS token CLS 1 by passing the embedded data through a first attention layer L 1. Next, the determination module 120 may derive a second CLS token CLS 2 by passing the first CLS token CLS 1 through a second attention layer L 2. In this manner, the determination module 120 may pass embedded data through the first attention layer L 1 to an N-th attention layer L N to derive the first CLS token CLS 1 to an N-th CLS token CLS N.

In step S306, the determination module 120 may derive a final token from one or more of two or more CLS tokens according to a preset criterion, and generate information on whether profanity is included based on the derived final token.

Meanwhile, the last CLS token CLS N that has passed through the last attention layer L N has more information loss due to processing than the previous CLS tokens L 1 to L N−1. Accordingly, if only the last CLS token CLS N is considered, the detection sensitivity for deformed profanity may be reduced.

Accordingly, the determination module 120 of the present disclosure may derive a final token that determines whether profanity is included by taking as input not only the last CLS token CLS N that has passed through the last attention layer L N, but also all CLS tokens CLS 1 to CLS N that have passed through all attention layers L 1 to L N.

Specifically, as shown in FIG. 4, the determination module 120 may derive an average value of all CLS tokens CLS 1 to CLS N that have passed through all attention layers L 1 to L N as a final token A CLS.

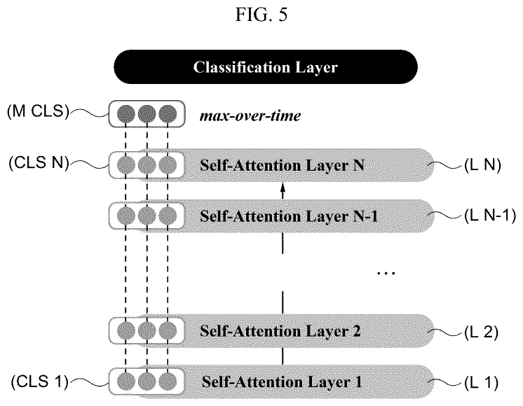

As shown in FIG. 5, the determination module 120 may derive the maximum CLS token among all CLS tokens CLS 1 to CLS N that have passed through all attention layers L 1 to L N as a final token M CLS.

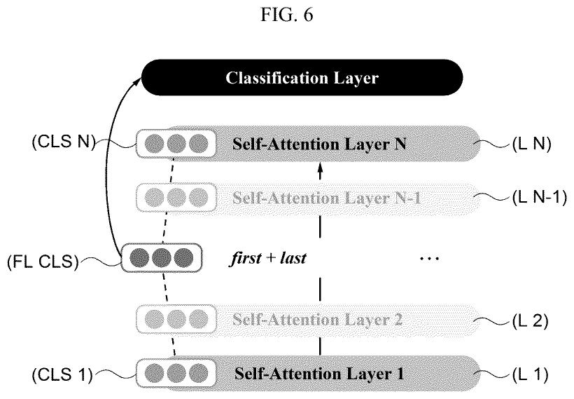

As shown in FIG. 6, the determination module 120 may combine the first CLS token CLS 1 that has passed through the first attention layer L 1 and the Nth CLS token CLS N that has passed through the last attention layer L N to derive the combined CLS token as a final token FL CLS. In this case, the first CLS token CLS 1 that has passed through the first attention layer L 1 may be the CLS token with the least amount of deformation and information loss.

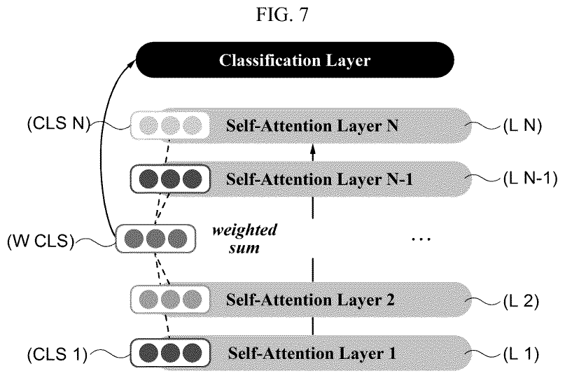

As shown in FIG. 7, the determination module 120 may derive a final token W CLS by applying a different weight to each of the CLS token CLS 1 to CLS N, each of which has passed through each of attention layers L 1 to L N, and then combining the weighted CLS token CLS 1 to CLS N.

Next, the determination module 120 may generate information on whether the sentence contains profanity based on a preset criterion from the derived final token.

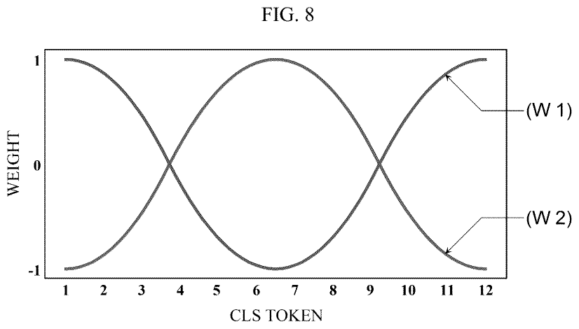

FIG. 8 is a diagram illustrating a method for assigning, by a determination module, weights to a plurality of CLS tokens through a plurality of attention layers, in an apparatus for detecting profanity according to an embodiment of the present disclosure.

Referring to FIG. 8, the determination module 120 may derive a final token W CLS by applying a different weight to each of the CLS token CLS 1 to CLS N that has passed through each of the attention layers L 1 to L N and then combining the weighted CLS token.

In an exemplary embodiment, the determination module may perform the attentions twelve times and derive the first CLS token CLS 1 to the twelfth CLS token each resulted from each of the attentions performed. Each of the 12 CLS tokens CLS 1 to CLS 12 may have a weight from −1 to 1.

In an exemplary embodiment, the determination module 120 may apply a higher weight to the first CLS token CLS 1 that has passed through the first attention layer L 1 and the last CLS token CLS N that has passed through the last attention layer L N than to the CLS tokens CLS 2 to CLS N−1 that have passed through the intermediate attention layers L 2 to L N−1, as in the down-up weight line W 1.

Specifically, the determination module 120 may apply weights, which gradually decrease and then gradually increase from the first CLS token to the last CLS token, to the CLS tokens CLS 1 to CLS N. The first CLS token CLS 1 has a weight of 1, and the subsequent CLS tokens have weights that gradually decrease therefrom, and the sixth CLS token CLS 6 and the seventh CLS token CLS 7 have weights close to −1, and the subsequent CLS tokens have weights that gradually increase therefrom, and the last 12th CLS token CLS 12 may have a weight of 1.

The application of weights that gradually decrease and then increase may be set to reflect the fact that the first CLS token CLS 1 best preserves the meaning of the original text and the last CLS token CLS N best represents the aggressiveness of the sentence.

In an exemplary embodiment, the determination module 120 may apply a lower weight to the first CLS token CLS 1 that has passed through the first attention layer L 1 and the last CLS token CLS N that has passed through the last attention layer L N than to the CLS tokens CLS 2 to CLS N−1 that have passed through the intermediate attention layers L 2 to L N−1, as in the up-down weight line W 2.

Specifically, the determination module 120 may apply weights, which gradually increase and then gradually decrease from the first CLS token CLS 1 to the last CLS token CLS N, to the CLS tokens CLS 1 to CLS N. The first CLS token CLS 1 has a weight of −1, and the subsequent CLS tokens have weights that gradually increase therefrom, and the sixth CLS token CLS 6 and the seventh CLS token CLS 7 have weights close to 1, and the subsequent CLS tokens have weights that gradually decrease therefrom, and the last 12th CLS token CLS 12 may have a weight of −1.

According to the disclosed embodiment, the present disclosure generates information on whether a sentence contains profanity based on not only the last CLS token CLS N that has passed through the last attention layer L N, but also all CLS tokens CLS 1 to CLS N that have passed through all attention layers L 1 to L N, thereby enabling detection of deformed profanity with high accuracy.

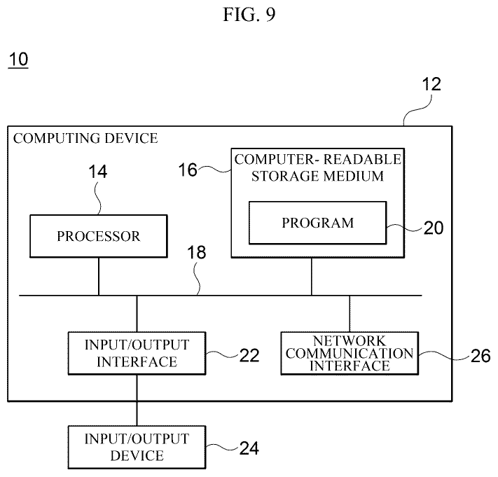

FIG. 9 is a block diagram for illustratively describing a computing environment including a computing device suitable for use in exemplary embodiments. In the illustrated embodiment, respective components may have different functions and capabilities other than those described below, and include additional components in addition to those described below.

The illustrated computing environment 10 includes a computing device 12. In an embodiment, the computing device 12 may be an apparatus for detecting profanity 100.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In an embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

According to the embodiments of the present disclosure, it is possible to provide a profanity detection technology with high detection sensitivity even for deformed profanity is required as well.

Although representative embodiments of the present invention have been described in detail above, those skilled in the art will understand that various modifications may be made to the above-described embodiments without departing from the scope of the present invention. Therefore, the scope of the present invention should not be limited to the described embodiments, but should be defined not only by the patent claims described below but also by those equivalent to the patent claims.

What is claimed is:

1. A method performed in a computing device that includes one or more processors and a memory storing one or more programs executed by the one or more processors, the method comprising:
acquiring sequence data converted from a sentence input by a user, and generating embedded data containing one or more tokens by embedding the acquired sequence data; and
training a neural network model to output information on whether the sentence contains profanity by inputting the generated embedded data into the neural network model.

2. The method of claim 1, wherein the neural network model includes a neural network configured to derive information on whether the sentence contains profanity by analyzing the acquired embedded data, and
the training of the neural network model includes adjusting weights of the parameters constituting the neural network of the neural network model so that a difference between the information derived on whether the sentence contains profanity and information labeled on whether the sentence contains profanity is minimized.

3. The method of claim 1, wherein the training of the neural network model includes:
deriving a plurality of sequential CLS tokens each corresponding to each of attention layers by sequentially passing the embedded data through a plurality of attention layers that perform attention;
deriving a final token from two or more CLS tokens among the plurality of CLS tokens according to a preset criterion; and
classifying whether the sentence contains profanity based on the final token.

4. The method of claim 3, wherein the final token is derived by averaging of the plurality of CLS tokens.

5. The method of claim 3, wherein the final token is derived from the largest CLS token among the plurality of CLS tokens.

6. The method of claim 3, wherein the final token is derived by combining a first CLS token and a last CLS token among the plurality of sequential CLS tokens.

7. The method of claim 3, wherein the final token is derived by combining the plurality of CLS tokens after applying a weight to each of the plurality of CLS tokens.

8. The method of claim 7, wherein a first CLS token and a last CLS token among the plurality of sequential CLS tokens have a greater weight than that of the remaining CLS tokens.

9. The method of claim 8, wherein the weights of the plurality of sequential CLS tokens gradually decrease and then increase from the first CLS token to the last CLS token among the plurality of sequential CLS tokens.

10. An apparatus for detecting profanity that includes one or more processors and a memory storing one or more programs executed by the one or more processors, the apparatus comprising:
an embedding module configured to acquire sequence data converted from a sentence input by a user, and to generate embedded data containing one or more tokens by embedding the acquired sequence data; and
a determination module configured to train a neural network model to output information on whether the sentence contains profanity by inputting the generated embedded data into the neural network model.

11. The apparatus of claim 10, wherein the neural network model includes a neural network configured to derive information on whether the sentence contains profanity by analyze the acquired embedded data, and
the determination module is configured to adjust weights of the parameters constituting the neural network of the neural network model so that a difference between the information derived on whether the sentence contains profanity and information labeled on whether the sentence contains profanity is minimized.

12. The apparatus of claim 10, wherein the determination module is configured to:
derive a plurality of sequential CLS tokens each corresponding to each of the attention layers by sequentially passing the embedded data through a plurality of attention layers that perform attention;
derive a final token from two or more CLS tokens among the plurality of CLS tokens according to a preset criterion; and
classify whether the sentence contains profanity based on the final token.

13. The apparatus of claim 12, wherein the final token is derived by combining the plurality of CLS tokens after applying a weight to each of the plurality of CLS tokens.

14. The apparatus of claim 13, wherein a first CLS token and a last CLS token among the plurality of sequential CLS tokens have a greater weight than that of the remaining CLS tokens.

15. A computer program stored in a non-transitory computer readable storage medium, wherein the computer program includes one or more instructions, and the instructions, when executed by a computing device including one or more processors, cause the computing device to perform:
acquiring sequence data converted from a sentence input by a user, and generating embedded data containing one or more tokens by embedding the acquired sequence data; and
training a neural network model to output information on whether the sentence contains profanity by inputting the generated embedded data into the neural network model.
